(19) United States
(12) Patent Application Publication
(10) Pub. No.: US 2019/0306067 A1
(43) Pub. Date: Oct. 3, 2019

(54) END-TO-END PRIORITY NETWORK DELIVERY ENFORCING APPLICATION PROTOCOL

(71) Applicant: Konica Minolta Laboratory U.S.A., Inc., San Mateo, CA (US)

(72) Inventor: Rahul Suraparaju, San Mateo, CA (US)

(73) Assignee: Konica Minolta Laboratory U.S.A., Inc., San Mateo, CA (US)

(21) Appl. No.: 15/942,013

(22) Filed: Mar. 30, 2018

(51) Int. Cl. H04L 12/801; H04L 29/06; H04L 12/851; H04L 29/08; G06F 3/12

(52) U.S. Cl. CPC H04L 47/19; H04L 69/161; H04L 47/18; H04L 47/24; H04L 67/322; H04L 69/329; G06F 3/1263; G06F 3/1222; G06F 3/1209; H04L 63/0263; G06F 3/1238

(57) ABSTRACT

A method is disclosed for prioritizing network delivery of Internet Protocol (IP) packets, the method comprising: hosting a database of users on a server, each of the users having a network delivery priority attribute for at least one application layer protocol; receiving the network delivery priority attribute from the database on the server upon authentication of a user; and creating an application protocol data unit (APDU) packet for a job, the APDU including an APDU header and a APDU payload, the APDU header including a protocol header with the network delivery priority attribute of the user for the job.

### FIELD OF THE INVENTION

The present disclosure generally relates to an end-to-end priority network delivery enforcing application protocol, and more particularly to an application protocol in the application layer of Transmission Control Protocol/Internet Protocol (TCP/IP) stack, which proving user level priorities from an active directory (AD) server, after the user is authenticated, for application layer protocols, for example, e-mail (or Internet Message Access Protocol (IMAP)), File Transfer Protocol (FTP), Server Message Block (SMB), and Internet Printing Protocol (IPP).

### BACKGROUND OF THE INVENTION

Current application layer protocols used by multi-functional peripherals (MFPs) do not offer support for programming network (Internet Protocol) level network delivery priority for the IP packets when sending e-mail data, FTP data, SMB data, and IPP data to the corresponding servers. For example, in a large enterprise made up of large number of MFPs, an e-mail server, a FTP server, and a SMB server serving several users provides the flat priority on the end-to-end network delivery of packets sent from source to destination, which may not be optimal to many businesses. For example, when the Chief Executive Officer (CEO) of the company scans a document and sends an e-mail, it may be desired that the company policy to be enforced is that all the packets for this network communication (i.e., e-mail) is prioritized over those packets (or e-mails) being sent by other users (for example, non-executive or non-directors) on a same shared enterprise local area network (LAN).

### SUMMARY OF THE INVENTION

In consideration of the above issues, it would be desirable to have a method and system, wherein different priorities can be assigned to individuals within a company or enterprise for different network operations including, for example, sending e-mail, scanning documents to SMB, uploading data and/or documents to a FTP server, or sending print jobs by IPP by pre-configuring the priorities on an active directory (AD) server. For example, the protocol can set network delivery priority attributes (for example, as “high” or “low”), according to a user's profile, and assigning a corresponding priority to the corresponding application protocol header, the Transmission Control Protocol (TCP) header, and the Internet Protocol (IP) header for all the packets being sent to a destination application server, for example, a computer, a multi-functional peripheral (MFP) or printer, and/or a mobile computer.

A method is disclosed for prioritizing network delivery of Internet Protocol (IP) packets, the method comprising: hosting a database of users on a server, each of the users having a network delivery priority attribute for at least one application layer protocol; receiving the network delivery priority attribute from the database on the server upon authentication of a user; creating an application protocol data unit (APDU) packet for a job, the APDU including an APDU header and a APDU payload, the APDU header including a protocol header with the network delivery priority attribute of the user for the job; establishing a Transmission Control Protocol (TCP) connection with a destination for the APDU packet; configuring a TCP header for the APDU packet in accordance with the network delivery priority attribute for the user and the job; configuring an IP header for the APDU packet in accordance with the network delivery priority attribute for the user and the job; sending the APDU packet to an application server; and processing the job on the application server.

A non-transitory computer readable medium (CRM) storing computer readable program code executed by a processor for prioritizing network delivery of Internet Protocol (IP) packets is disclosed, comprising: receiving a network delivery priority attribute for at least one application layer protocol on a computer or multi-functional peripheral (MFP); creating an application protocol data unit (APDU) packet for a job, the APDU including an APDU header and a APDU payload, the APDU header including a protocol header with the network delivery priority attribute of the user for the job; establishing a Transmission Control Protocol (TCP) connection with a destination for the APDU packet; configuring a TCP header for the APDU packet in accordance with the network delivery priority attribute for the user and the job; configuring an IP header for the APDU packet in accordance with the network delivery priority attribute for the user and the job; and sending the APDU packet to an application server.

A method is disclosed for prioritizing network delivery of Internet Protocol (IP) packets, the method comprising: hosting a database of users on a server, each of the users having a network delivery priority attribute for at least one application layer protocol; receiving the network delivery priority attribute from the database on the server upon authentication of a user; and creating an application protocol data unit (APDU) packet for a job, the APDU including an APDU header and a APDU payload, the APDU header including a protocol header with the network delivery priority attribute of the user for the job.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system with end-to-end priority network delivery enforcing application protocol in accordance with an exemplary embodiment.

FIG. 2 is an illustration of a multi-functional peripheral or printer in accordance with an exemplary embodiment.

FIG. 3 is an illustration of a computer, a router, or a server in accordance with an exemplary embodiment.

FIG. 4 is an illustration of an end-to-end priority application protocol application showing packet flow for an e-mail in accordance with an exemplary embodiment.

FIG. 5 is an illustration of an exemplary packet for an e-mail in accordance with an exemplary embodiment.

FIG. 6 is an illustration of a database of users (or user-names) and corresponding network delivery priority attributes for e-mail priority, FTP-priority, SMB-priority, and print priority in accordance with an exemplary embodiment.

FIG. 7 is an illustration of a format of a packet with a delivery priority in accordance with an exemplary embodiment.

FIG. 8 is an illustration of a graphical user interface on a computer for applying a priority property for an application level, a TCP level, and an IP level.

FIG. 9 is an illustration of a graphical user interface on a computer for setting a priority level for the application level, the TCP level, and the IP level as set forth in FIG. 8.

FIG. 10 is an illustration of flowchart showing a process for end to end priority network delivery enforcing application protocol executed in a multi-functional peripheral (MFP) or printer in accordance with an exemplary embodiment.

FIG. 11 is an illustration of flowchart showing a process for end to end priority network delivery enforcing application protocol executed in a router in accordance with an exemplary embodiment.

FIG. 12 is an illustration of flowchart showing a process for end to end priority network delivery enforcing application protocol executed in accordance with an exemplary embodiment.

FIG. 13 is an illustration of flowchart showing a process for end to end priority network delivery enforcing application protocol executed in accordance with an exemplary embodiment.

FIG. 14 is an illustration of flowchart showing a process for end to end priority network delivery enforcing application protocol executed in accordance with an exemplary embodiment.

FIG. 15 is an illustration of flowchart showing a process for end to end priority network delivery enforcing application protocol executed in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

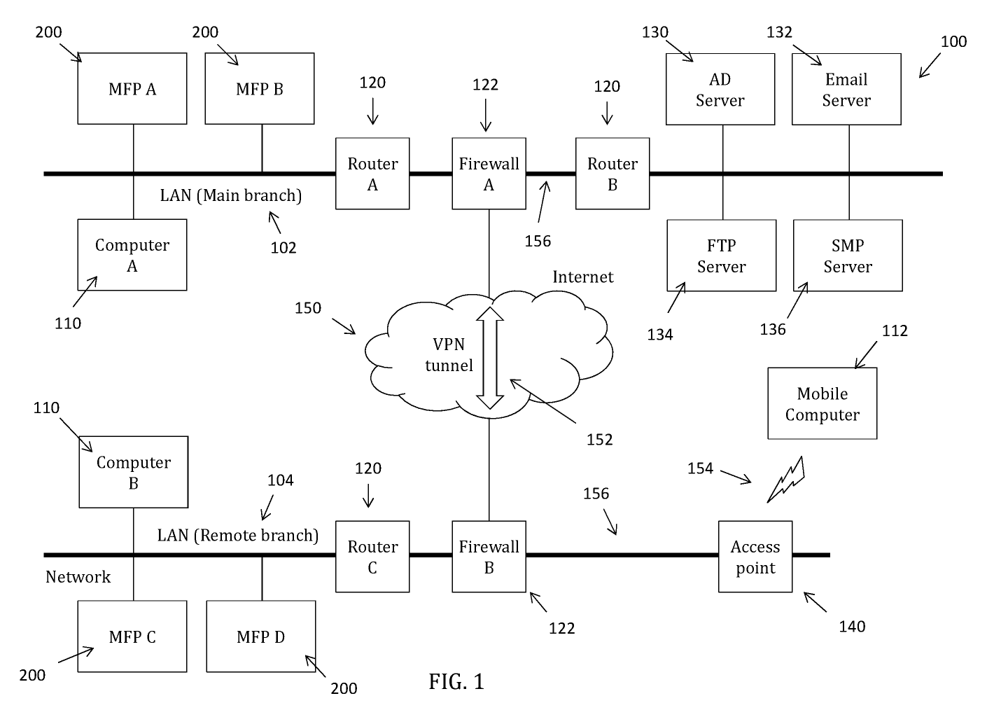

FIG. 1 is an illustration of a system 100 with end-to-end priority network delivery enforcing application protocol in accordance with an exemplary embodiment. As shown in FIG. 1, the system 100 can provide end-to-end priority network delivery enforcing application protocol, for example, between a main branch (or primary office or branch) 102 and a remote branch (or secondary office or branch) 104 having local area networks (LANs) and which branches 102, 104 are in communication via a communication network 150, for example, the Internet. In accordance with an exemplary embodiment, the system 100 can include a plurality of computers 110, at least one mobile computer 112, a plurality of multi-functional peripherals (MFP) 200, one or more routers 120, and one or more firewalls 122. The system 100 can also include an active directory (AD) server 130, an e-mail server 132, a File Transfer Protocol (FTP) server 134, and a Server Message Block (SMB) server 136.

In accordance with an exemplary embodiment, the plurality of computers 110, the at least one mobile computer 112, the plurality of multi-functional peripherals (MFP) 200, the one or more routers 120, the one or more firewalls 122, the active directory (AD) server 130, the e-mail server (or IMPA server) 132, the File Transfer Protocol (FTP) server 134, and the Server Message Block (SMB) server 136 can be connected via a communication network 150, which can include a virtual private network (VPN) 152, which extends a private network across a public network. In addition, for example, an access point 140 can communicate with the communication network 150 to provide wireless or cellular data communication 154 between the mobile computer (for example, a smart phone) 112, and the communication network 150. In accordance with an exemplary embodiment, the access point 140 can be any networking hardware device that allows a Wi-Fi device to connect to a wired network, or a hardware device that can allow a cellular device, for example, a smartphone to connect to the wired network 150.

In accordance with an exemplary embodiment, the one or more routers 120 are networking devices configured to forward data packets between the two or more branches 102, 104. The one or more routers 120 forward the data packet from one of the one or more routers 120 to an other of the one or more routers 120 through the communication network 150 until the data packet reaches its destination node. Each of the two or more branches 102, 104, can include a firewall 122 (or networking device) that monitors and controls incoming and outgoing network traffic based on predetermined security rules for the branches 102, 104.

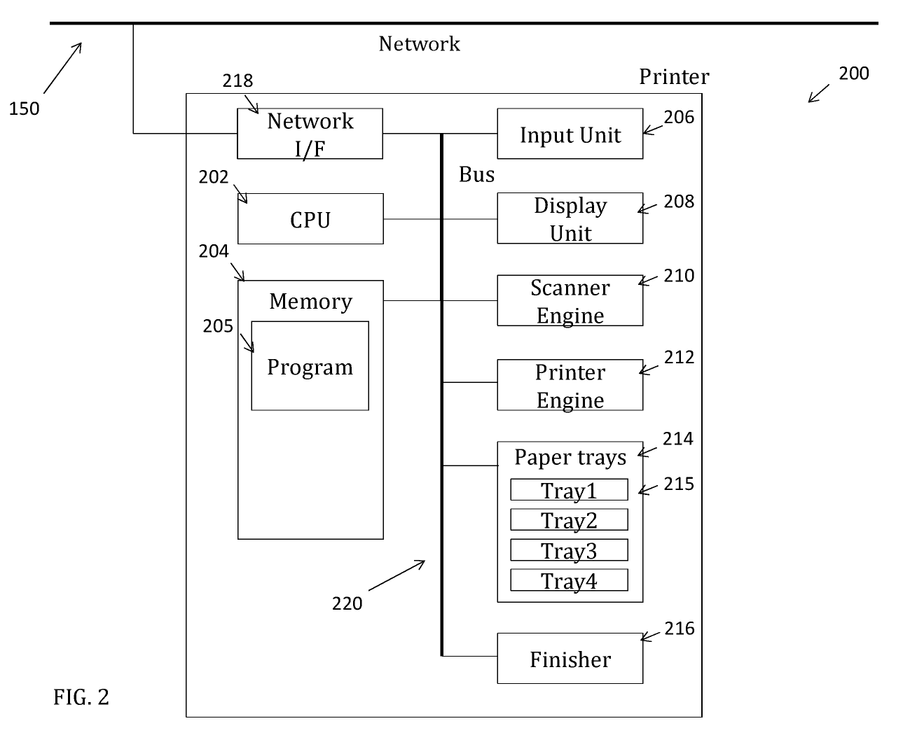

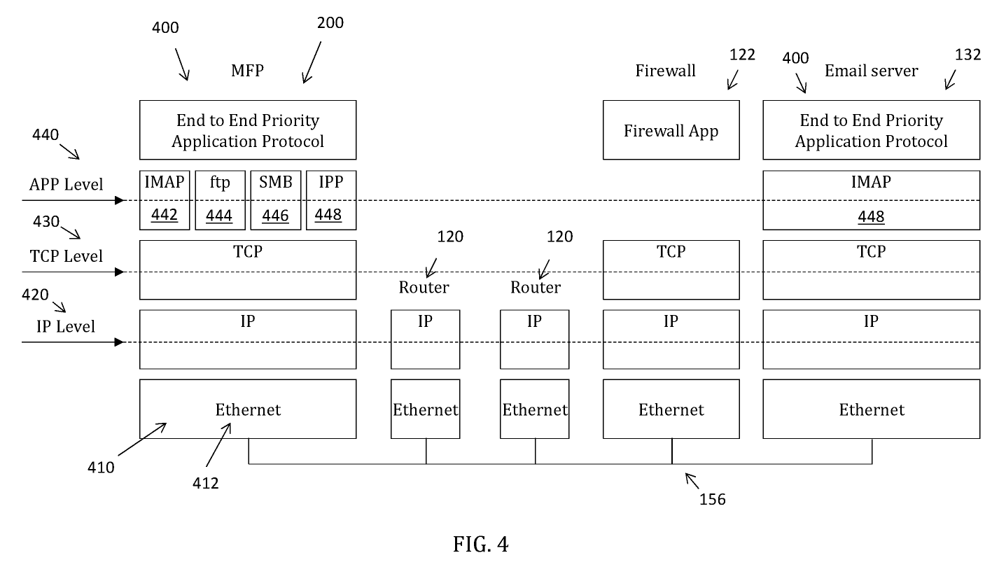

FIG. 2 is an illustration of a multi-functional peripheral or printer 200 in accordance with an exemplary embodiment. As shown in FIG. 4, the printer 200 can include a network interface (I/F) 218, which is connected to the communication network (or network) 150, a processor or central processing unit (CPU) 202, and one or more memories 204 for storing software programs and data 205 (such as files to be printed). For example, the software programs can include a printer controller and a tray table. The processor or CPU 202 carries out the instructions of a computer program, which operates and/or controls at least a portion of the functionality of the printer 200. The printer 200 can also include an input unit 206, a display unit or graphical user interface (GUI) 208, the network interface (I/F) 218, a scanner engine (or scanner) 210, a printer engine 212, and at least one paper tray 214,and more preferably a plurality of paper trays 215, and a finisher 216. A bus 220 can connect the various components 202, 204, 206, 208, 210, 212, 214, 216, 218 within the printer 200. The printer 200 also includes an operating system (OS), which manages the computer hardware and provides common services for efficient execution of various software programs. In accordance with an exemplary embodiment, it can be within the scope of the disclosure for the printer 200 to be a copier.

For example, in accordance with an exemplary embodiment, an image processing section within the printer 200 can carry out various image processing under the control of a print controller or CPU 202, and sends the processed print image data to the print engine 212. The image processing section can also include a scanner section (not shown) for optically reading a document, such as an image recognition system. The scanner section receives the image from the scanner and converts the image into a digital image. The printer engine 212 forms an image on a print media (or recording sheet) based on the image data sent from the image processing section. The central processing unit (CPU) (or processor) 202 and the memory 204 can include a program for RIP processing (Raster Image Processing), which is a process for converting print data included in a print job into Raster Image data to be used in the printer engine 212. The CPU 202 can include a printer controller configured to process the data and job information received from the one or more computing devices 300, for example, received via the network connection unit and/or input/output section (I/O section) 218.

The CPU 202 can also include an operating system (OS), which acts as an intermediary between the software programs and hardware components within the multi-function peripheral. The operating system (OS) manages the computer hardware and provides common services for efficient execution of various software applications. In accordance with an exemplary embodiment, the printer controller can process the data and job information received from the one or more client computers 10 to generate a print image. In accordance with an exemplary embodiment, the OS of the CPU 202 is a Linux or Windows® based operating system.

In accordance with an exemplary embodiment, the network I/F 218 performs data transfer with the at least one computing device 300. The printer controller can be programmed to process data and control various other components of the multi-function peripheral to carry out the various methods described herein. In accordance with an exemplary embodiment, the operation of printer section commences when the printer section receives a page description from the one or more computing devices 300 via the network I/F 218 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of MFP or printers 200 consistent with exemplary embodiments of the disclosure include, but are not limited to, a multi-function peripheral (MFP), a laser beam printer (LBP), an LED printer, a multi-function laser beam printer including copy function.

As shown in FIG. 2, the printer 200 can also include at least one auto tray or paper tray 214, and more preferably a plurality of auto trays or paper trays 215. Each auto tray or paper tray 214 can include a bin or tray, which holds a stack of a print media, for example, a paper or a paper-like product. The printer engine or print engine 212 has access to a print media of various sizes and workflow for a print job, which can be, for example, stored in the input tray. A “print job” or “document” can be a set of related sheets, usually one or more collated copy sets copied from a set of original print job sheets or electronic document page images, from a particular user, or otherwise related.

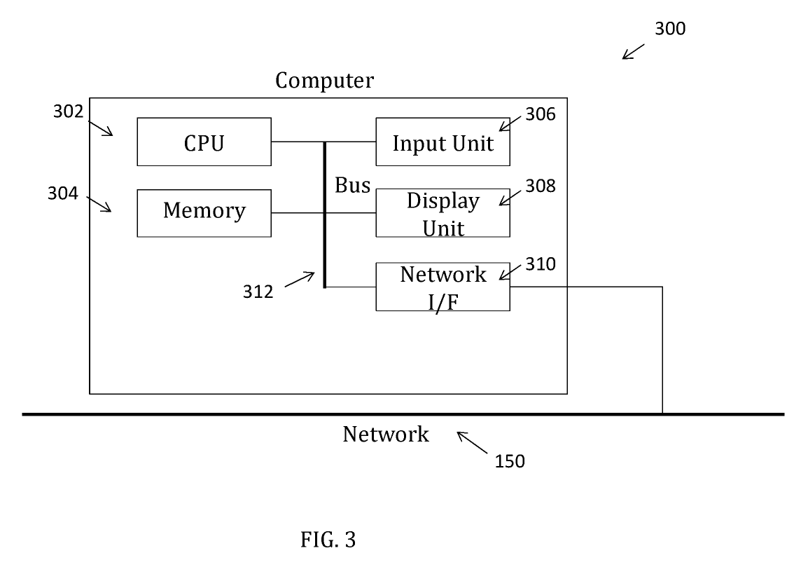

FIG. 3 is an illustration of a computing device 300, which can be a computer 110, a mobile computer 112, a router 120, an AD server 130, an e-mail server 132, a FTP server 134, or a SMP server 136. As shown in FIG. 3, the exemplary computing device 300 can include a processor or central processing unit (CPU) 302, and one or more memories 304 for storing software programs and data (such as files to be printed), and an optional printer driver. The printer driver of the computing device 300 is preferably a software application that converts data to be printed into a form specific for the MFP or printer 200. The processor or CPU 302 carries out the instructions of a computer program, which operates and/or controls at least a portion of the functionality of the computing device 300. The computing device 300 can also include an input unit 306, a display unit or graphical user interface (GUI) 308, and a network interface (I/F) 310, which is connected to a communication network (or network) 150. A bus 312 can connect the various components 302, 304, 306, 308, 310 within the computing device 300.

In accordance with an exemplary embodiment, the one or more computing devices 300 each can include a display unit or graphical user interface (GUI) 308, which can access, for example, a web browser (not shown) in the memory 304 of the computing device 300. The computing device 300 also includes an operating system (OS), which manages the computer hardware and provides common services for efficient execution of various software programs. In accordance with an exemplary embodiment, the OS of the CPU 302 is a Linux or Windows® based operating system. The software programs can include, for example, application software and printer driver software. For example, the printer driver software controls a multifunction printer or printer 200, for example connected with the computing device 300 in which the printer driver software is installed via the communication network 150. In certain embodiments, the printer driver software can produce a print job and/or document based on an image and/or document data. In addition, the printer driver software can control transmission of the print job from the computing device 300 to the router 110, the firewall 120, the AD server 130, the e-mail server 132, the FTP server 134, and the SMP server 136 and/or the printer or printing device 200.

In accordance with an exemplary embodiment, the communication network or network 150 can be a public telecommunication line and/or a network (for example, LAN or WAN). Examples of the communication network 150 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

FIG. 4 is an illustration of an end-to-end priority application protocol (end-to-end priority application) 400 showing packet flow for an e-mail in accordance with an exemplary embodiment. As shown in FIG. 4, the MFP 200 can include a set of communication protocols (for example, programs 205) hosted in the memory 204, for example, an Internet protocol suite, which is a set of communication protocols used on the Internet and similar computer networks, and which provide end-to-end data communication specifying how data should be packetized, addressed, transmitted, routed, and received.

The Internet protocol suite is organized into four abstraction layers, which classify all related protocol according to the scope of the networking involved. For example, from the lowest to highest, the layers are the link layer 410, for example, Ethernet 412, containing communication methods for data that remains within a single network segment (link); the Internet Protocol layer (or IP layer) 420, providing internetworking between independent networks; the transport layer (for example, the Transmission Control Protocol or TCP layer) 430 handling host-to-host communication; and the application layer 440, which provides process-to-process data exchange for applications. For example, as shown in FIG. 4, the application layer 440 can include applications for IMAP 442, ftp 444, SMB 446, and Internet Printing Protocol (IPP) 448. As shown in FIG. 4, for example, the MPF (or printer) 200 has a network interface 218 ((FIG. 3), for example, an Ethernet 412), which is in communication with the communication network 150, including the one or more routers 120, a firewall 122, and an e-mail server 132.

In accordance with an exemplary embodiment, the end-to-end priority application 400 can be configured to provide a method and system, wherein different priorities can be assigned to individuals within a company or enterprise 102, 104 for different network operations including, for example, sending e-mail 442, uploading data and/or documents to a FTP server 444, scanning documents to SMB 446, and Internet Printing Protocol (IPP) 448 by pre-configuring the priorities on the active directory (AD) server 130. For example, the protocol can set priorities, (for example, “high” or “low”), according to a user's profile, and assigning a corresponding priority to the corresponding application protocol header 440, TCP header 430, and IP header 420 for all the packets being sent to a destination application server, for example, a computer 110, a mobile computer 112, and/or a MFP or Printer 200.

In accordance with an exemplary embodiment, the active directory (AD) server 130 can include a listing of each employee within an enterprise, a company, a business, or a portion of the enterprise, a portion of the company, or a portion of the business, and the active directory (AD) server 130 can host and assign each employee a priority level (or network delivery priority attribute) for one or more application level programs as disclosed herein. For example, only certain directors and executives may be assigned a high priority designation, which can allow network delivery priority (of packets) for the user, for example, for sending e-mails, scanning documents, sharing access to files, printers, and serial ports and miscellaneous communications between nodes, and print jobs in accordance with the IMAP, the FTP, the SMB, and the IPP protocols.

In accordance with an exemplary embodiment, each of the one or more devices within the main branch 102 and the remote branch 104 can include an end-to-end priority application 400, which is preferably hosted in a memory of the device, for example, the computer 110, the mobile computer 112, and the MFP (or printer) 200. The end-to-send priority application protocol 400 can be configured upon user login or authentication, for example, a password, which is a word or string of characters, which can be used for authentication to provide access and/or approval to the computer 110, the mobile computer 112, and the MFP (or printer) 200. Upon authentication of the user, the computer 110, the mobile computer 112, or the MFP (or printer) 200 can access the active directory (AD) server 130, which hosts network delivery priority attributes for each user and the one or more application protocols, for example, IMAP 442, FTP 444, SMB 446, and IPP 448, and depending on the assigned priority to the user, the corresponding network operation can be sent with a higher priority, and the corresponding application protocol header, TCP header, and the IP header for all packets being sent towards a destination server, for example, a computer 110, a mobile computer 112, and a MFP (or printer) 200. In accordance with an exemplary embodiment, for example, “priority” can be defined as a processing order for the packet in comparison to other packets being sent via a same protocol, for example, IMAP 442.

In accordance with an exemplary embodiment, for example, the end-to-end priority application protocol 400 can be used to send an e-mail from a computer 110, a mobile computer 112, or a MFP (or printer) 200 for a user having a high priority, for example, an executive or director, and upon receiving the “high priority designation” from the AD server 130, each e-mail being sent via the IMAP protocol can receive priority over other e-mails being sent with the “high priority designation” in accordance with the IMAP protocol. For example, in accordance with an exemplary embodiment, the “high priority designation” for IMAP can be designated for a packet queue, which is a high priority queue, which is emptied more quickly than a lower priority queue in the LAN network 156. For example, the “high priority designation” can include expedited forwarding (for example, no delay) and the “low priority designation” can include, for example, “best effort” forwarding.

In accordance with an exemplary embodiment, the “high priority designation”, which expedites end-to-end delivery can include at the at the TCP protocol layer, the TCP immediately “pushes” all the data it has towards the recipient's TCP as soon as it is able to do so, without waiting for more data. For example, in a default mode (for efficiency purposes), the TCP layer will wait for the application layer 400 (for example, data from the IMAP 442, FTP 444, SMB 446, or IPP 448) to add more bytes before the TCP layer will pass the data to the IP layer. For example, one of the goals of the TCP layer is to make use of the entire maximum segment size (MSS) (which, for example, is 1460 bytes). In an expedited-mode, the TCP layer can send the data packet as soon as application has any data to send (for example, the data may only be 100 bytes). The next set of data, for example, 200 bytes will be sent in a different packet. Alternatively, in a “low priority designation”, which can be a best effort end-to-end delivery, in the TCP protocol layer, the TCP layer will wait for the application to send more bytes so that it can make a TCP segment that is MSS size (1460-bytes).

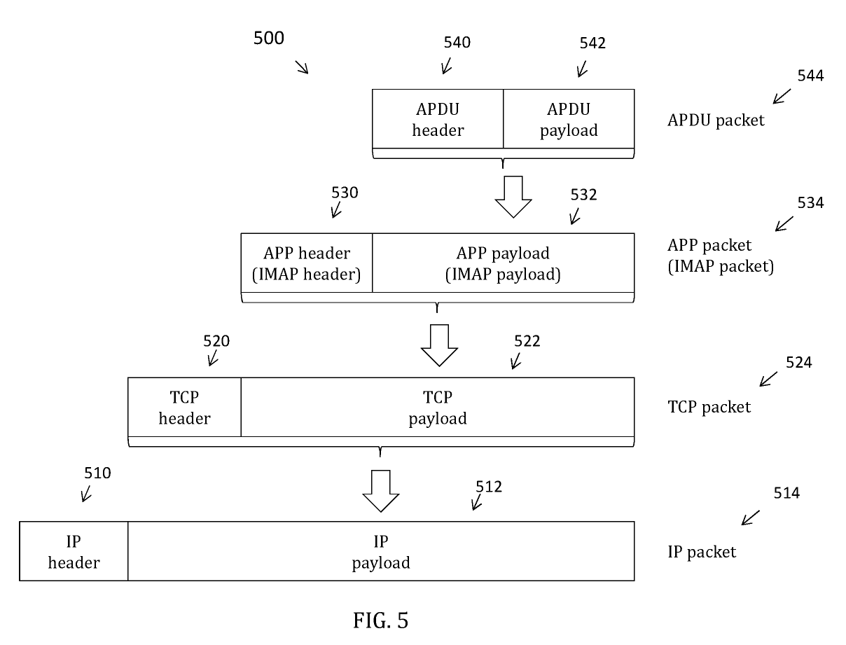

FIG. 5 is an illustration of an exemplary packet 500 for an e-mail in accordance with an exemplary embodiment. As shown in FIG. 5, the packet 500 can have an IP packet 514 having an IP header 510 and an IP payload 512, a TCP packet 524 having a TCP header 520 and a TCP payload 522, an application packet (APP) packet (for example, an IMAP packet) 534 having an APP header (IMAP header) 530 and an APP payload (IMAP payload) 532, and application protocol data unit (APDU) packet 544 having APDU header 540 and an APDU payload 542.

In accordance with an exemplary embodiment, the APDU packet 544 is generated by the end-to-end priority application 400 hosted on the computer 110, mobile computer 112, or MPF (or printer) 200 upon a request, for example, to send an e-mail pursuant to the IMAP protocol, and after receipt of the network delivery priority attributes for the user from the AD server 130. For example, the APDU packet 544 includes the APDU payload, for example, an e-mail, and a corresponding APDU header 540, which includes a network delivery priority attribute (or priority) for the user, which is then applied to the e-mail being sent according to the IMAP protocol. In accordance with an exemplary embodiment, a same network delivery priority attribute for the user can also be set for each of the TCP/IP protocols, for example, the application level protocol, the TCP level protocol, and the IP level protocol each having the same priority designation, for example, “high priority”.

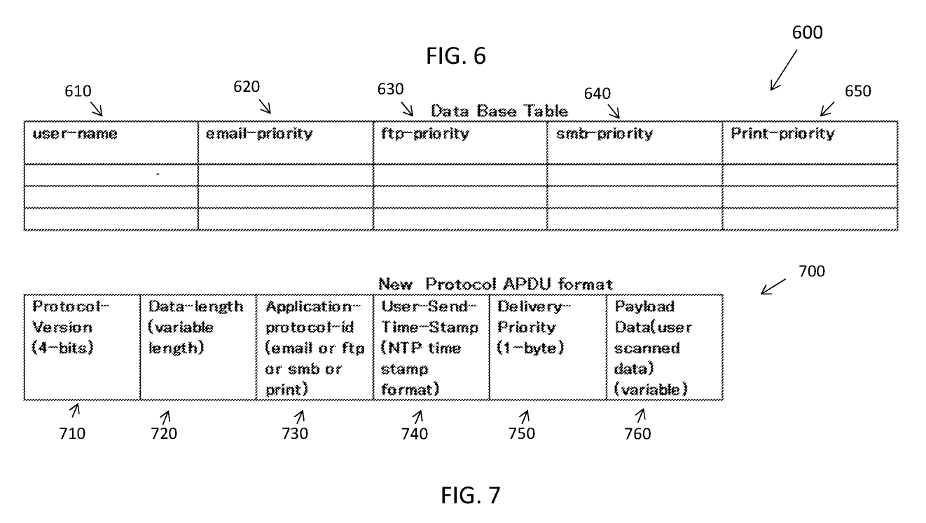

FIG. 6 is an illustration of a database 600 of users (or user-names) 610 and corresponding network delivery priority attributes for e-mail priority 620, FTP-priority 630, SMB-priority 640, and print priority 650 in accordance with an exemplary embodiment. As shown in FIG. 6, in accordance with an exemplary embodiment, the AD server 130 can host a database of user (user-names) and corresponding priority levels for one or more application protocols 620, 630, 640, 650. For example, the network delivery priority for each of the users can be set to “high priority” or “normal priority” (i.e., “low priority”). Alternatively, more than two levels of priority (for example, levels 1, 2, 3, 4, for example, from “high priority” to “low priority”) can be set if the application level protocol, the TCP level protocol, and the IP level protocol provides more than two levels of prioritization of packet delivery.

FIG. 7 is an illustration of a format of a packet 700 with a delivery priority in accordance with an exemplary embodiment. As shown in FIG. 7, the packet 700 can have a format, which includes protocol version (4-bits) 710, data-length (variable length) 720, application-protocol-id (for example, e-mail, FTP, SMP, or print) 730, User-send- time-stamp (NTP time stamp format) 740, Delivery priority (for example, 1-byte) 750, and payload data (user scanned data) (variable length) 760.

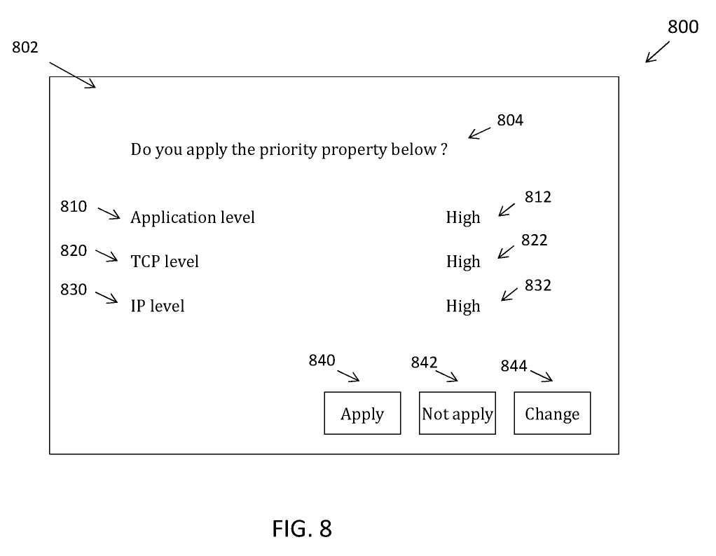

FIG. 8 is an illustration of a graphical user interface (GUI) 802 on a computing device 300 for applying a network delivery priority attribute (or priority property) for the application level protocol 810, the TCP level protocol 820, and the IP level protocol 830. In accordance with an exemplary embodiment, the GUI 802 can be accessed, for example, by an administrator, who has authority to set the network delivery priority attributes (or priority property) 812, 822, 832, for each of the users, for example, at the application level protocol 810, the TCP level protocol 820, and the IP level protocol 830. For example, the GUI 802 can include a prompt, which asks, “Do you apply the priority property below?” 804. The GUI 802 can also include graphical icons or visual indicators that can “Apply” 840, “Not Apply” 842 and/or “Change” 844 network delivery priority attributes (i.e., priority property) to one or more of the level protocols 810, 820, 830.

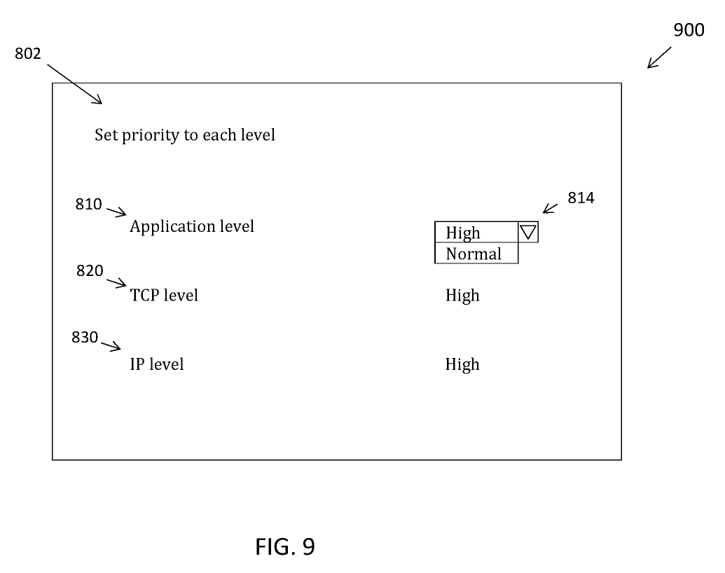

FIG. 9 is an illustration of a graphical user interface 802 on a computing device 300 for setting a priority level for the application level protocol 810, the TCP level protocol 820, and the IP level protocol 830 as set forth in FIG. 8. As set forth, for example, in accordance with an exemplary embodiment, the application level protocol 810, the TCP level protocol 820, and the IP level protocol 830 can be assigned with a pull-down menu 814, for example, “High” (for example, a “high priority designation”) or “Normal” (for example, a “low priority designation”).

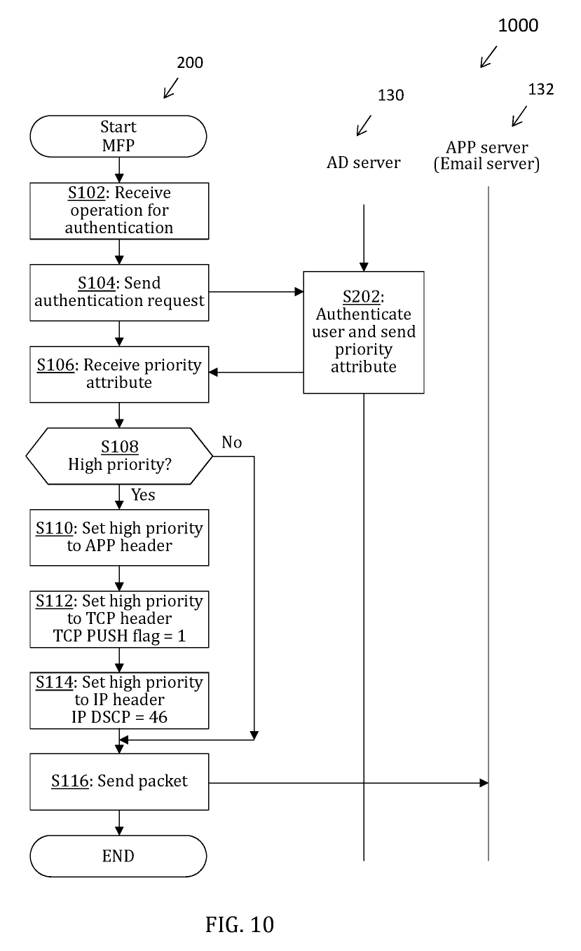

FIG. 10 is an illustration of flowchart 1000 showing a process for end to end priority network delivery enforcing application protocol executed in a multi-functional peripheral (MFP) or printer 200 in accordance with an exemplary embodiment. In accordance with an exemplary embodiment, in step S102, the MFP or printer 200 receives an operation for authentication of a user, for example, via a login identifier (user name) and a password. After authentication of the user, in step S104, the MFP or printer 200 sends an authentication request to the AD server 130, which hosts the network delivery priority attributes of the user as disclosed herein. In step S202, the AD server 130 authenticate the user and sends priority attributes to the MFP or printer 200 for the user, which are received by the MFP or printer 200 in step S106. In step S108, the end-to-end priority application 400 receives the network delivery priority attributes (priority attributes) for the user from the AD server 130. In step S108, if the priority attributes for the user are “high”, for example, the user is an executive or director, in step S110, the end-to-end priority application protocol 400 generates the APDU packet 544 (FIG. 5) with a “high” priority and establishes the TCP connection. In step S112, the TCP header (for example, TCP PUSH flag=1) can be set to high priority (for example, the TCP_NODELAY). In step S114, the IP DSCP value can be set, for example, to 46 (critical) and in step S116, the packet is sent out with the high priority, for example, no delay within the queue, to the application server (APP server), for example, the e-mail server 132 for delivery via the communication network 150 to a computer 110, a mobile computer 112, or an other MFP or printer 120.

In accordance with an exemplary embodiment, in step S108, if the application protocol for the user is not “high priority”, the data packet can be sent to the application server (APP server 132) with a normal delivery, for example, no priority attribute or value.

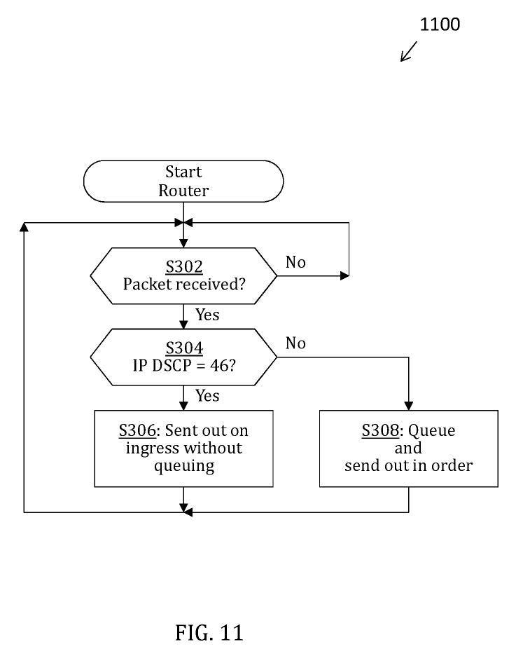

FIG. 11 is an illustration of flowchart 1100 showing a process for end to end priority network delivery enforcing application protocol executed in a router 120 in accordance with an exemplary embodiment. As shown in FIG. 11, in step S302, the router 120 receives the packet from, for example, the e-mail server 132. In step S304, the router 120 reads the priority information, for example, IP DSCP=46, which indicates that the packet is to be sent out on ingress (for example, after an ingress filter has ensured that the incoming packet is actually from the network from which the packet claims to originate) in step S306 without queuing. Alternatively, if the packet does not have a high priority, the packet is queued and sent out in order according to routing policy of the router 120.

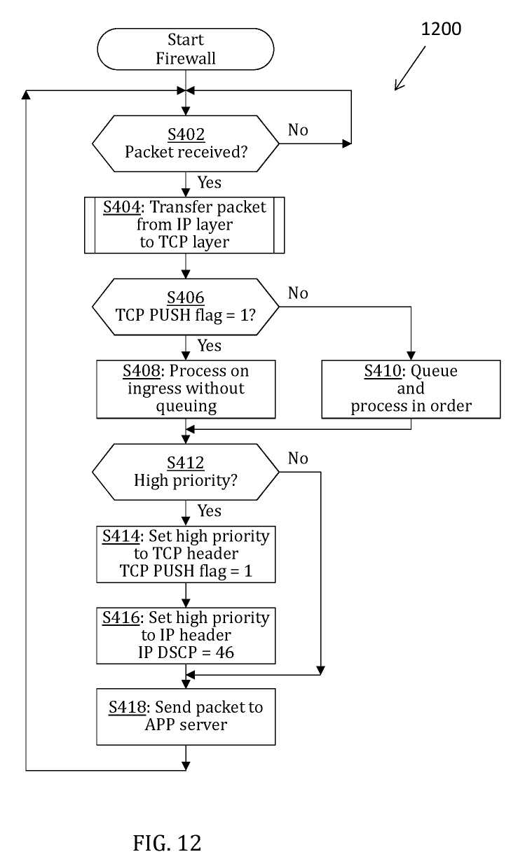

FIG. 12 is an illustration of flowchart 1200 showing a process for end to end priority network delivery enforcing application protocol executed in accordance with an exemplary embodiment having a firewall 122. As shown in FIG. 12, in step S402, the packet is received by the firewall (or network security system) 122 and the packet is transferred from the IP layer to the TCP layer in step S404. In step S406, if the packet has a high priority, for example, the TCP PUSH flag=1, the packet continues to step S408, where the packet is processed on ingress without queuing. Alternatively, if the packet is a low priority or normal priority, for example, the TCP PUSH flag is not equal to 1, in step S410, the packet is queued and processed in order.

In accordance with an exemplary embodiment, in step S412, the packet can be processed by the firewall (or network security system) 122 and a determination can be made if the packet has been assigned a high priority. If the packet has been assigned a high priority, in step S414, the TCP header can be set to high priority, for example, TCP PUSH flag=1. In step S416, the IP header can be set to high priority, for example, IP DSCP=46, and in step S418, the packet is sent to the APP server, for example, the e-mail server 132.

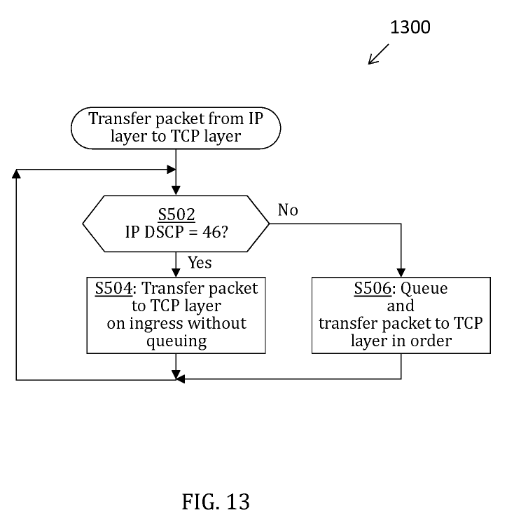

FIG. 13 is an illustration of flowchart 1300 showing a process for end to end priority network delivery enforcing application protocol executed in accordance with an exemplary embodiment. As shown in FIG. 13, the packet can be transferred from the IP layer to the TCP layer. In step S502, if the IP DSCP is equal to 46 (for example, high priority), in step S504, the packet is transferred to the TCP layer on ingress without queuing. If the IP DSCP is not equal to 46 (for example, no high priority) the packet is queued and transferred to the TCP layer in order without assigning the packet any priority.

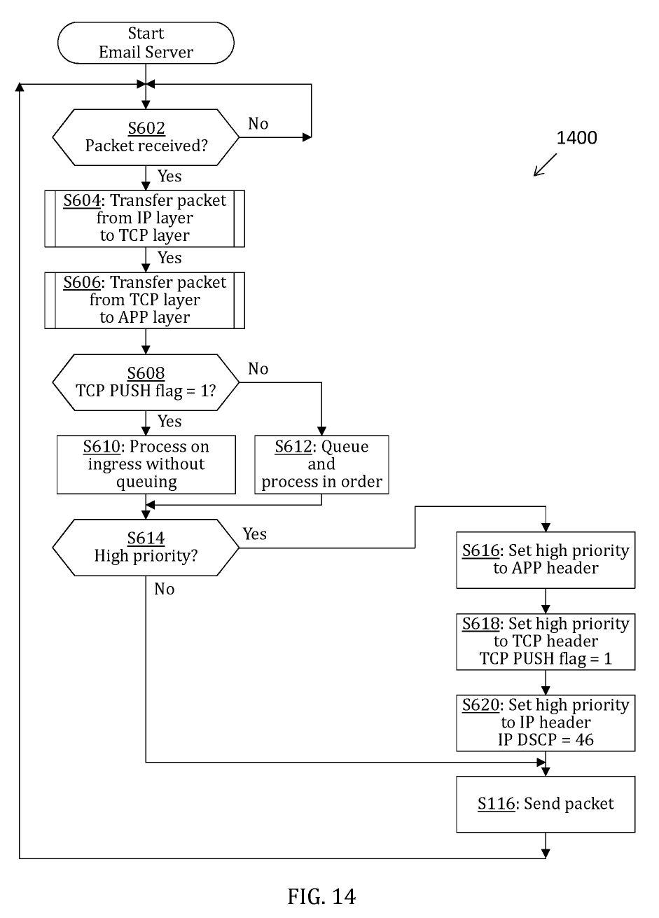

FIG. 14 is an illustration of flowchart 1400 showing a process for end to end priority network delivery enforcing application protocol executed in accordance with an exemplary embodiment. As shown in FIG. 14, the packet is received by the application server, for example, the e-mail server 132. In step S804, the packet is transferred from the IP layer to the TCP layer. In step S606, the packet is transferred from the TCP layer to the application layer. In step S608, a determination is made if the TCP PUSH flag=1 (for example, priority). If the TCP PUSH flag is equal to 1 (for example, the packet has been assigned) priority, the packet is processed on ingress without queuing in step S810. Alternatively, if the TCP PUSH flag for the packet is not equal to 1, the packet can be queued and processed in order.

In accordance with an exemplary embodiment, if the packet has been assigned a priority, in S614, the packet is processed in step S616 by setting the APP header to high priority. In step S618, the TCP header is set to high priority and the TCP PUSH flag is set to 1, and in step S820, the IP header can be set to IP DSCP=46. In step S116, the packet can be sent by the e-mail server 132 via the communication network 150 (and VPN tunnel 152) to a computer 110, a mobile computer 112, or a MFP or printer 120.

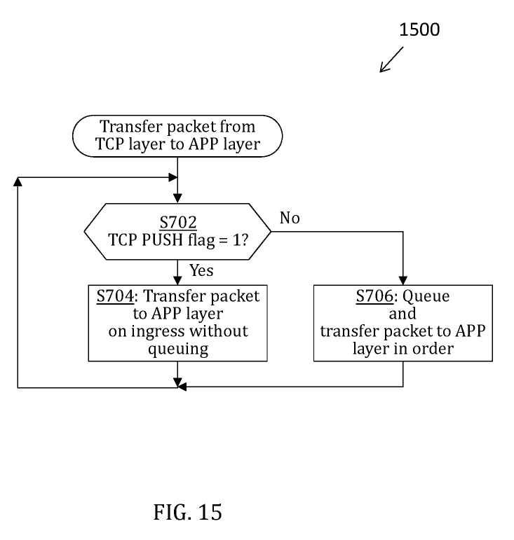

FIG. 15 is an illustration of flowchart 1500 showing a process for end to end priority network delivery enforcing application protocol executed in accordance with an exemplary embodiment. As shown in FIG. 15, the packet is transferred from the TCP layer to the APP layer. In step S702, if the TCP PUSH flag is equal to 1 (for example, high priority), in step S704, the packet is transferred to the TCP layer on ingress without queuing. If the TCP PUSH flag is not equal to 1 (for example, no high priority) the packet is queued and transferred to the APP layer in order without assigning the packet any priority.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A method for prioritizing network delivery of Internet Protocol (IP) packets, the method comprising:
hosting a database of users on a server, each of the users having a network delivery priority attribute for at least one application layer protocol;
authenticating a user on a computing device, the user being one of the users in the database of users on the server;
requesting the network delivery priority attribute for the user from the database for a job, the job configured to be sent via the at least one application layer protocol;
receiving the network delivery priority attribute for the user from the database;
creating an application protocol data unit (APDU) packet for the job on the computing device, the APDU packet including an APDU header and a APDU payload, the APDU header including a protocol header with the network delivery priority attribute of the user for the job;
establishing a Transmission Control Protocol (TCP) connection with a destination for the APDU packet;
configuring a TCP header for the APDU packet in accordance with the network delivery priority attribute for the user and the job;
configuring an IP header for the APDU packet in accordance with the network delivery priority attribute for the user and the job;
sending the APDU packet to an application server from the computing device in accordance with the network delivery priority attribute for the user and the job; and
processing the job on the application server in accordance with the network delivery priority attribute for the user and the job.

2. The method of claim 1, wherein the at least one application layer protocol comprises one or more of the following:
an Internet Message Access Protocol (IMAP), a File Transfer Protocol (FTP), a Server Message Block (SMB), and an Internet Printing Protocol (IPP).

3. The method of claim 1, further comprising:
routing the APDU packet in accordance with the IP header for the APDU packet in accordance with the network delivery priority attribute for the user and the job.

4. The method of claim 1, wherein the network delivery priority attribute includes at least a high priority designation and a low priority designation, the high priority designation comprising sending the APDU packet on ingress without queuing, and the lower priority designation comprising sending the APDU packet in a queue and sending the APDU packet in accordance with a queuing protocol or policy.

5. The method of claim 1, further comprising:
routing the APDU packet through a firewall in accordance with the network delivery priority attribute of the user.

6. The method of claim 1, further comprising:
sending the APDU packet to the application server; and
processing the APDU packet in the application server in accordance with the network delivery priority attribute of the user.

7. The method of claim 1, wherein the computing device is a computer or a multi-functional peripheral (MFP), the method further comprising:
hosting an APDU application on the computer or the multi-functional peripheral (MFP), the APDU application configured to obtain the network delivery priority attribute of the user from the server and formatting the APDU packet in accordance with the network delivery priority attribute of the user.

8. The method of claim 1, wherein the computing device is a computer or a multi-functional peripheral (MFP), and wherein the job is an e-mail, a scan job on the multi-functional peripheral (MFP), an upload or a transfer of a computer file, or a print job.

9. A non-transitory computer readable medium (CRM) storing computer readable program code executed by a processor for prioritizing network delivery of Internet Protocol (IP) packets, comprising:
receiving a network delivery priority attribute for at least one application layer protocol upon authentication of a user on a computer or multi-functional peripheral (MFP);
creating an application protocol data unit (APDU) packet for a job on the computer or the multi-functional peripheral (MFP), the job configured to be sent via the at least one application layer protocol, the APDU packet including an APDU header and a APDU payload, the APDU header including a protocol header with the network delivery priority attribute of the user for the job;
establishing a Transmission Control Protocol (TCP) connection with a destination for the APDU packet;
configuring a TCP header for the APDU packet in accordance with the network delivery priority attribute for the user and the job;
configuring an IP header for the APDU packet in accordance with the network delivery priority attribute for the user and the job; and
sending the APDU packet to an application server from the computer or multi-functional peripheral (MFP), and wherein the APDU packet is configured to be sent from the computer or multi-functional peripheral (MFP) in accordance with the network delivery priority attribute for the user and the job and to be processed by the application server in accordance with the network delivery priority attribute for the user and the job.

10. The non-transitory CRM of claim 9, comprising:
receiving the network delivery priority attribute for the at least one application layer protocol upon the authentication of the user on the computing device or multi-functional peripheral (MFP) from a database of a server, the sever being configured to host hosting a database of users, each of the users having a network delivery priority attribute for at least one application layer protocol.

11. The non-transitory CRM of claim 9, further comprising:
processing the job on the application server in accordance with the network delivery priority attribute of the user for the job.

12. The non-transitory CRM of claim 9, wherein the at least one application layer protocol comprises one or more of the following:
an Internet Message Access Protocol (IMAP), a File Transfer Protocol (FTP), a Server Message Block (SMB), and an Internet Printing Protocol (IPP).

13. The non-transitory CRM of claim 9, further comprising:
routing the APDU packet in accordance with the IP header for the APDU packet in accordance with the network delivery priority attribute for the user and the job.

14. The non-transitory CRM of claim 9, wherein the network delivery priority attribute includes at least a high priority designation and a low priority designation, the high priority designation comprising sending the APDU packet on ingress without queuing, and the lower priority designation comprising sending the APDU packet in a queue and sending the APDU packet in accordance with a queuing protocol or policy.

15. The non-transitory CRM of claim 9, further comprising:
routing the APDU packet through a firewall in accordance with the network delivery priority attribute of the user.

16. The non-transitory CRM of claim 9, further comprising:
sending the APDU packet to the application server; and
processing the APDU packet in the application server in accordance with the network delivery priority attribute of the user.

17. The non-transitory CRM of claim 9, further comprising:
hosting an APDU application on the computer or the multi-functional peripheral (MFP), the APDU application configured to obtain the network delivery priority attribute of the user from the server and formatting the APDU packet in accordance with the network delivery priority attribute of the user.

18. The non-transitory CRM of claim 9, wherein the job is an e-mail, a scan job on a multi-functional peripheral (MFP), an upload or a transfer of a computer file, or a print job.

19. A method for prioritizing network delivery of Internet Protocol (IP) packets, the method comprising:
hosting a database of users on a server, each of the users having a network delivery priority attribute for at least one application layer protocol;
authenticating a user on a computing device, the user being one of the users in the database of users on the server;
requesting the network delivery priority attribute for the user from the database for a job, the job configured to be sent via the at least one application layer protocol;
receiving the network delivery priority attribute for the user from the database on; and
creating an application protocol data unit (APDU) packet for the job on the computing device, the APDU packet including an APDU header and a APDU payload, the APDU header including a protocol header with the network delivery priority attribute of the user for the job to be sent by the computing device in accordance with the network delivery priority attribute for the user and the job and processed by an application server in accordance with the network delivery priority attribute for the user and the job.

20. The method of claim 19, wherein the at least one application layer protocol comprises one or more of the following:
an Internet Message Access Protocol (IMAP), a File Transfer Protocol (FTP), a Server Message Block (SMB), and an Internet Printing Protocol (IPP); and
wherein the network delivery priority attribute includes at least a high priority designation and a low priority designation, the high priority designation comprising sending the APDU packet on ingress without queuing, and the lower priority designation comprising sending the APDU packet in a queue and sending the APDU packet in accordance with a queuing protocol or policy.
